(19) United States
(12) Patent Application Publication
(10) Pub. No.: US 2012/0082556 A1
(43) Pub. Date: Apr. 5, 2012

(54) NANOCRYSTALLINE METAL COATED COMPOSITE AIRFOIL

(76) Inventors: Enzo Macchia, Kleinburg (CA); Andreas Eleftheriou, Woodbridge (CA); George Guglielmin, Toronto (CA); Barry Bamett, Markham (CA); Joe Lanzino, Orangeville (CA); Thomas McDonough, Barrie (CA)

(21) Appl. No.: 13/189,077

(22) Filed: Jul. 22, 2011

Related U.S. Application Data
(60) Provisional application No. 61/388,384, filed on Sep. 30, 2010.

(51) Int. Cl. F01D 5/14; B05D 5/00; B05D 1/36

(52) U.S. Cl. 416/241 A; 427/404; 427/256

(57) ABSTRACT

An airfoil for a gas turbine engine comprising a root, a tip, and leading and trailing edges extending between the root and the tip. The airfoil has a non-metallic core which is composed of a composite material, and a metallic coating disposed on at least a portion of the composite core, such as along the leading edge of the airfoil for example. The metallic coating is composed of a nanocrystalline metal, and forms an outer surface of the portion of the airfoil onto which the coating is applied.

### CROSS-REFERENCE TO RELATED APPLICATIONS

The present application claims priority on U.S. Provisional Patent Application No. 61/388,384 filed Sep. 30, 2010, the entire contents of which is incorporated herein by reference.

### TECHNICAL FIELD

The application relates generally to airfoils, such as those used in gas turbine engines, and more particularly to composite vane airfoils.

### BACKGROUND

Compressor vanes in aero gas turbine engines are typically designed to have low maintenance costs. This is typically achieved by: designing the vane to be field replaceable; designing the vane such that repair is as simple as possible; and designing the vane such that it is so robust that it is not prone to foreign object damage (FOD) and erosion and sees little damage in the field. Usually, gas turbine vanes are manufactured from aluminum, steel or from carbon fiber composites. Typically the airfoil shapes have been relatively simple, enabling vanes to be manufactured from simple metal forming methods. Aerodynamic performance improvements have led to more complex shapes especially on the leading edge (LE), which results in metal vanes that must be machined from solid bars.

Increasing demands for lower weight products have seen an increasing use of carbon fibre composite products, especially vanes. FOD (foreign object damage) resistance, including to ice projectiles for example, and erosion resistance for carbon composite vanes is typically achieved by a metal sheath that is bonded onto the leading edge (LE). When the vane LE shape is relatively simple, the manufacture and application of the metal sheath is straightforward, however when the LE is a complex shape, the metal sheath is required to be manufactured from alternative methods such as hydroforming and this results in higher cost. Other problems with the existing leading edge sheathes include: poor geometric matching of the substrate surface with the metal sheath: the need for a strong durable adhesive; difficulty in controlling the geometric properties; problems with edges; and achieving smooth undetectable transition surfaces.

Accordingly, improvements are desirable.

### SUMMARY

In accordance with one aspect of the present application, there is provided an airfoil for a gas turbine engine comprising a root, a tip, and leading and trailing edges extending between the root and the tip, the airfoil having a non-metallic core composed of a composite and a metallic coating on at least a portion of the core, the metallic coating being composed of a nanocrystalline metal forming an outer surface of said portion of the airfoil.

In accordance with another aspect of the present application, there is provided a method of manufacturing an airfoil for a gas turbine engine, the method comprising the steps of: providing a core from a composite material, the core of the airfoil defining a leading edge and a trailing edge; and applying a nanocrystalline metal coating over at least a portion of the core.

A stator of a gas turbine engine is also disclosed which has a plurality of vanes each having an airfoil as described above.

A gas turbine engine fan is also disclosed which includes a plurality of fan blades, each having an airfoil as described above.

There is further provided a stator of a gas turbine engine, the stator having a plurality of vanes each having an airfoil comprising a root, a tip, and leading and trailing edges extending between the root and the tip, the airfoil having a non-metallic core composed of a composite and a metallic coating on at least a portion of the core, the metallic coating being composed of a nanocrystalline metal forming an outer surface of the portion of the airfoil.

There is further provided a gas turbine engine fan including a plurality of fan blades, each of the fan blades having an airfoil comprising a root, a tip, and leading and trailing edges extending between the root and the tip, the airfoil having a non-metallic core composed of a composite and a metallic coating on at least a portion of the core, the metallic coating being composed of a nanocrystalline metal and forming an outer surface of the portion of the airfoil.

### DESCRIPTION OF THE DRAWINGS

Reference is now made to the accompanying figures in which:

FIG. 1 is a schematic cross-sectional view of a gas turbine engine;

FIG. 2 is a perspective view of a stator which can be used in a gas turbine engine such as that shown in FIG. 1;

FIG. 3 is a perspective view of a vane of the stator of FIG. 2;

FIG. 4 is a cross-sectional view of the vane of FIG. 3;

FIG. 5 is an exploded perspective view of an alternate stator which can be used in a gas turbine engine such as that shown in FIG. 1; and

FIG. 6 is a perspective view of a vane of the stator of FIG. 5.

### DETAILED DESCRIPTION

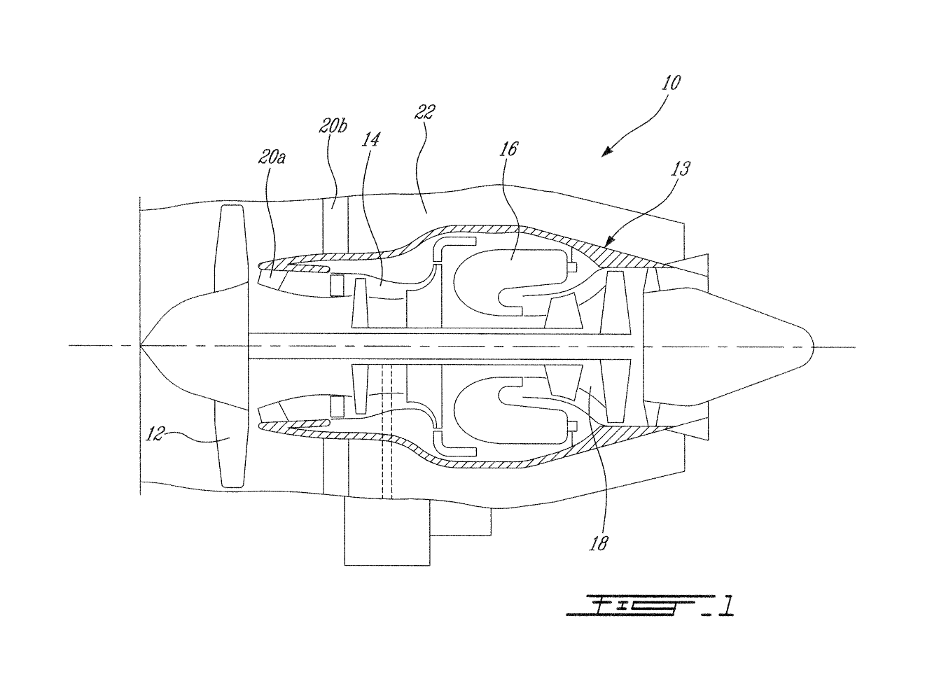

FIG. 1 illustrates a gas turbine engine 10 generally comprising in serial flow communication, a fan 12 through which ambient air is propelled, and a core 13 including a compressor section 14 for pressurizing the air, a combustor 16 in which the compressed air is mixed with fuel and ignited for generating an annular stream of hot combustion gases, and a turbine section 18 for extracting energy from the combustion gases.

The engine also includes a core fan exit guide vane or stator 20a located downstream of the fan 12 and guiding the primary airflow towards the compressor section 14. The engine further includes a bypass duct 22 surrounding the core 13 and through which part of the air propelled by the fan 12 is circulated, and a bypass fan exit stator 20b extending across the bypass duct 22 to guide the airflow therethrough.

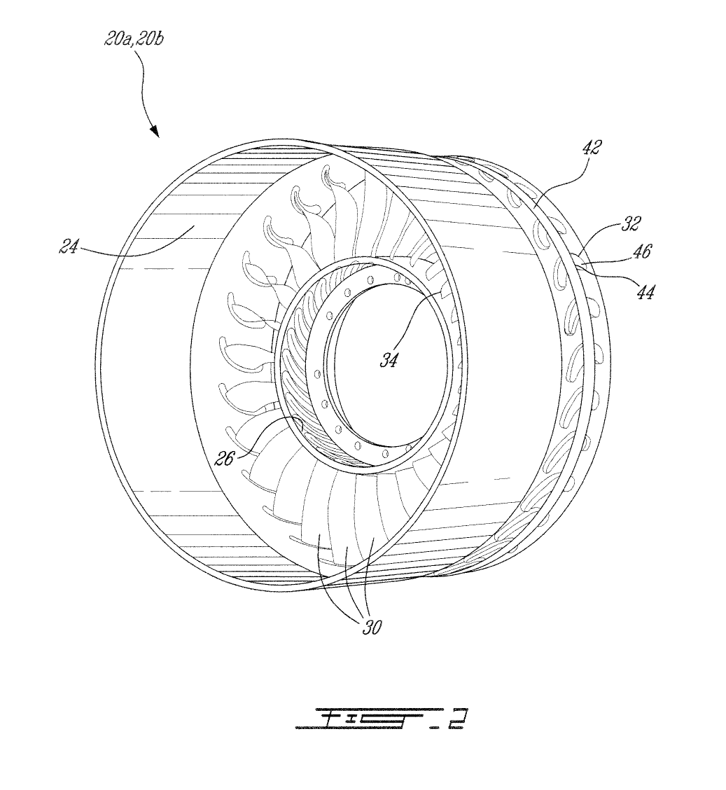

Referring to FIG. 2, an example of the stator 20a,20b is shown. In a particular embodiment, the stator 20a,20b corresponds to the core gaspath fan exit stator 20a or the bypass fan exit stator 20b. In an alternate embodiment, the stator may also be a stator or other airfoil of the compressor section 14. Alternatively still, the present teachings may be applied to any suitable gas turbine airfoil, whether fixed vanes airfoils or rotating blade airfoils, in the compressor section 14.

The stator 20a,20b includes an outer shroud 24 extending downstream or upstream of the blades of the fan or compressor, and an inner shroud 26 concentric with the outer shroud 24, the outer and inner shrouds 24, 26 defining an annular gas flow path therebetween. The outer shroud 24 can be part of, or separate from, the casing of the engine 10. A plurality of vanes 30 extend radially between the outer shroud 24 and the inner shroud 26.

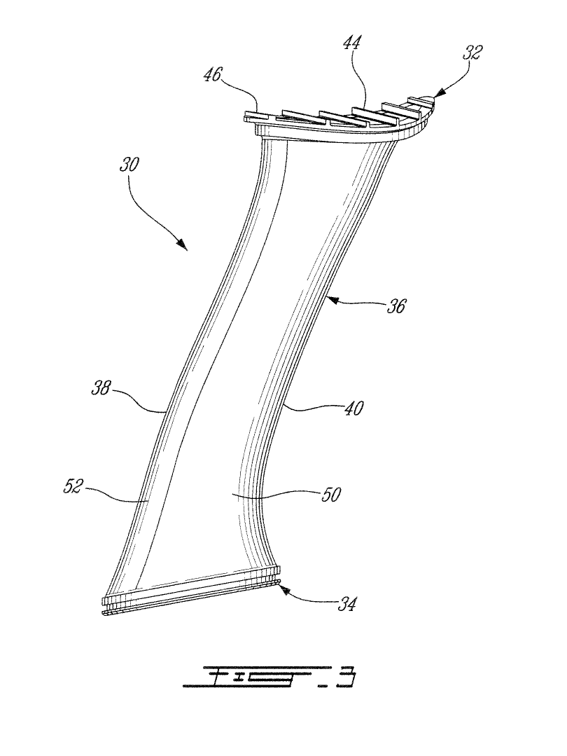

Referring to FIGS. 2-3, each of the vanes 30 has a vane tip 32 retained in the outer shroud 24 assembly, a vane root 34 retained in the inner shroud 26, and an airfoil portion 36 extending therebetween. The airfoil portion 36 of each vane 30 defines a relatively sharp leading edge 38 and a relatively sharp trailing edge 40, such that an airflow coming from the blades of the fan or compressor and passing through the stator 20a,20b flows over the vane airfoil 36 from the leading edge 38 to the trailing edge 40.

In the embodiment shown, the vanes are radially inserted into the case, and retained in place by either a circumferential strap 42 (see FIG. 2), which may be placed around the outer shroud 24 in aligned strap holders 44 defined in the outer surface 46 of the vane roots 32, or alternately by any other van retaining means suitable for positioning and holding the individual vanes in place within the case.

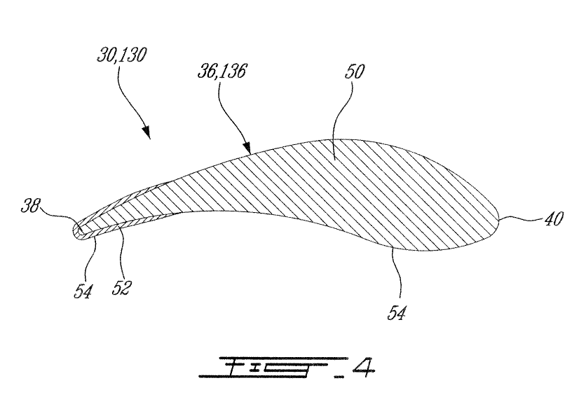

Referring to FIGS. 3-4, the airfoil portion 36 of each vane 30,130 is formed of a bi-material structure comprising a non-metallic core 50 made of a composite substrate material, such as a carbon fiber composite for example, with a nanocrystalline metallic outer coating or shell 52 covering at least a portion of the core and thus of the airfoil. Accordingly, a “hybrid” vane airfoil is thus provided. In one particular embodiment, the nanocrystalline metal coating is disposed on the airfoil along the leading edge (LE) thereof, or along a leading edge region which covers the LE itself and extends away therefrom in the direction of airflow along the pressure and suction sides of the airfoil. The nanocrystalline metal coating may extend away from the LE a desired distance, within this coating region. This desired distance may vary from only several millimetres, for example forming a small band covering the LE and the very forward surfaces of the pressure and suction sides of the airfoil, up to and including the full width of the airfoil such that the coating extends until the trailing edge (TE) and thus the nanocrystalline metal coating extends over the complete outer surface of the composite substrate material. The region of the airfoil having the nanocrystalline metal coating 52 may in fact extend, on both the pressure and suction side of the blade, from the LE up to the full width of the airfoil. Therefore, in the case of the coating being disposed about the full width of the airfoil, the composite core is thus fully encapsulated by the nanocrystalline metal coating.

Each vane 30 therefore includes a core 50 made of a composite substrate material, for example, a carbon fiber-reinforced composite using VRM37 resin (a trademark of Albany Composite). For simplicity, the core 50 is illustrated here as being solid, although it is understood that the core 50 can alternately be at least partially hollow and/or include heating, cooling or weight reduction channels or other openings defined therethrough. The core 50 may be manufactured through a resin transfer molding process, or any suitable process used to form the composite core. As will be seen in further detail below, the LE region 38 of the composite core 50 of the vane airfoil 36 is covered by a nanocrystalline metal (i.e. a nano-metal coating having a nano-scale crystalline structure) top coat 52, as will be described. Although the nanocrystalline metal LE coating may preferably be formed from a pure metal, as noted further below, in an alternate embodiment the nanocrystalline metal layer may also be composed of an alloy of one or more of the metals mentioned herein. Although multiple coats of the nanocrystalline metal may be applied to the LE 38 of the composite core 50 if desired and/or necessary, in a particular embodiment the LE topcoat 52 of the nanocrystalline metal is provided as a single layer, that is applied to the underlying substrate of the composite core 50.

Each vane 30 thus includes a single layer topcoat 52 of a nano-scale, fine grained pure metal covering a region of the core 50 confined to the leading edge 38, which is illustrated in FIG. 4 with an exaggerated relative thickness for clarity. The pure metal leading edge topcoat 52 thus defines the outer surface 54 of the vane around and along the full length of the leading edge 38, that is extending from the vane root 34 to the vane tip 32, as seen in FIG. 3. It is to be understood that the term “pure” is intended to include a metal comprising trace elements of other components. As such, in a particular embodiment, the pure Nickel coating includes trace elements such as but not limited to: C=200 parts per million (ppm), S<500 ppm, Co=10 ppm, O=100 ppm.

In a particular embodiment, the leading edge topcoat is applied directly to the carbon fiber substrate. Other types of bonding can include: surface activation, surface texturing, applied resin and surface grooves or other shaping. Another example, described in more detail in U.S. Pat. No. 7,591,745, which is incorporated herein, involves employing a layer of conductive material between the substrate and topcoat layer to improve adhesion and the coating process. In this alternate embodiment, an intermediate bond coat is first disposed on the composite substrate 50 before the nanocrystalline metallic topcoat 52 is applied along the LE 38 of the vane airfoil 36. This intermediate bond coat may improve adhesion between the nanocrystalline metal coating 52 and the composite substrate 50 and therefore improve the coating process, the bond strength and/or the structural performance of the nanocrystalline metal coating 52 that is bonded to the composite substrate 50.

Alternatively, the leading edge of the vane 30 can be formed separately a mold within which the nanocrystalline material is molded, such as to conform to the shape of the leading edge 38, and then be bonded onto the LE 38 of the airfoil 36 using any suitable adhesive of bonding technique.

The nanocrystalline metal top coat layer 52 has a time grain size, which provides improved structural properties of the vane 30. The nanocrystalline metal coating is a fine-grained metal, having an average grain size at least in the range of between 1 nm and 5000 nm. In a particular embodiment, the nanocrystalline metal coating has an average grain size of between about 10 nm and about 500 nm. More particularly, in another embodiment the nanocrystalline metal coating has an average grain size of between 10 nm and 50 nm, and more particularly still an average grain size of between 10 nm and 15 nm. The thickness of the single layer nanocrystalline metal topcoat 52 may range from about 0.001 inch (0.0254 mm) to about 0.125 inch (3.175 mm), however in a particular embodiment the single layer nano-metal topcoat 52 has a thickness of between 0.001 inch (0.0254 mm) and 0.008 inches (0.2032 mm). In another more particular embodiment, the nanocrystalline metal topcoat 52 has a thickness of about 0.005 inches (0.127 mm). The thickness of the topcoat 52 may also be tuned (i.e. modified in specific regions thereof, as required) to provide a structurally optimum part. For example, the nanocrystalline metal topcoat 52 may be formed thicker in expected weaker regions of the vane core 50, such as the leading edge 38, and thinner in other regions, such as the central region of the airfoil portion 36. The thickness of the metallic topcoat 52 may therefore not be uniform throughout the airfoil 36 or throughout the vane 30. This may be done to reduce critical stresses, reduce deflections and/or to tune the frequencies of the vane.

For example, the nanocrystalline metal coating 52 may having a greatest thickness at a LE of the airfoil, and taper in thickness along the surfaces of the airfoil extending away from the LE, thereby producing a tapered nanocrystalline metal coating. This tapered coating may extend either along only a portion of the airfoil surfaces or alternately along the full length of these surfaces such as to form a full, encapsulating, coating on the composite core. Alternately, of course, this full encapsulating coating may also be provided with the coating having a uniform thickness (i.e. a full uniform coating) throughout. In the above-mentioned embodiment wherein the nanocrystalline metal coating is applied to only a portion of the airfoil, this part-coating can either have a substantially constant thickness or a varied (ex: tapered or otherwise non-constant) thickness within this coated portion.

The nanocrystalline metal topcoat 52 may be a pure metal such one selected from the group consisting of: Ag, Al, Au, Co, Cu, Cr, Sn, Fe, Mo, Ni, Pt, Ti, W, Zn and Zr, and is purposely pure (i.e. not alloyed with other elements) to obtain specific material properties sought herein. The manipulation of the metal grain size, when processed according to the methods described below, produces the desired mechanical properties for a vane in a gas turbine engine. In a particular embodiment, the pure metal of the nanocrystalline metal topcoat 52 is nickel (Ni) or cobalt (Co), such as for example Nanovate™ nickel or cobalt (trademark of Integran Technologies Inc.) respectively, although other metals can alternately be used, such as for example copper (Cu) or one of the above-mentioned metals. The nanocrystalline metal topcoat 52 is intended to be a pure nano-scale Ni, Co, Cu, etc. and is purposely not alloyed to obtain specific material properties. It is to be understood that the term “pure” is intended to include a metal perhaps comprising trace elements of other components but otherwise unalloyed with another metal.

The topcoat 52 allows for the leading edge 38 of the vane to be protected regardless of the complexity of its shape, and also allows the leading edge 38 to be sharper than previously used metal strip coverings, thus reducing the boundary layer effect and as such improving performance. In a particular embodiment, the leading edge 38 is very sharp, e.g. 0.001 inch (0.0254 mm) thick, along the entire length of the leading edge.

In a particular embodiment, the topcoat 52 is a plated coating, i.e. is applied through a plating process in a bath, to apply a fine-grained metallic coating to the article, such as to be able to accommodate complex vane geometries with a relatively low cost. Any suitable coating process can be used, such as for instance the plating processes described in U.S. Pat. No. 5,352,266 issued Oct. 4, 1994; U.S. Pat. No. 5,433,797 issued Jul. 18, 1995; U.S. Pat. No. 7,425,255 issued Sep. 16, 2008; U.S. Pat. No. 7,387,578, issued Jun. 17, 2008; U.S. Pat. No. 7,354,354 issued Apr. 8, 2008; U.S. Pat. No. 7,591,745 issued Sep. 22, 2009; U.S. Pat. No. 7,387,587 B2 issued Jun. 17, 2008; and U.S. Pat. No. 7,320,832 issued Jan. 22, 2008; the entire content of each of which is incorporated herein by reference. Any suitable number of plating layers (including, one or multiple layers of different grain size, and/or a larger layer having graded average grain size and/or graded composition within the layer) may be provided. The nanocrystalline metal material(s) used for the topcoat 52 described herein may also include the materials variously described in the above-noted patents, namely in U.S. Pat. No. 5,352,266, U.S. Pat. No. 5,433,797, U.S. Pat. No. 7,425,255, U.S. Pat. No. 7,387,578, U.S. Pat. No. 7,354,354, U.S. Pat. No. 7,591,745, U.S. Pat. No. 7,387,587 and U.S. Pat. No. 7,320,832, the entire content of each of which is incorporated herein by reference.

In an alternate embodiment, the metal topcoat layer 52 may be applied to the composite core 50 using another suitable application process, such as by vapour deposition of the pure metal coating, for example. In this case, the pure metal coating may be either a nanocrystalline metal as described above or a pure metal having, larger scale grain sizes.

As mentioned, if required or desired the composite substrate surface can be rendered conductive, e.g. by coating the surface with a thin layer of silver, nickel, copper or by applying a conductive epoxy or polymeric adhesive materials prior to applying the coating layer(s). Additionally, the non-conductive polymer substrate may be rendered suitable for electroplating by applying such a thin layer of conductive material, such as by electroless deposition, physical or chemical vapour deposition, etc.

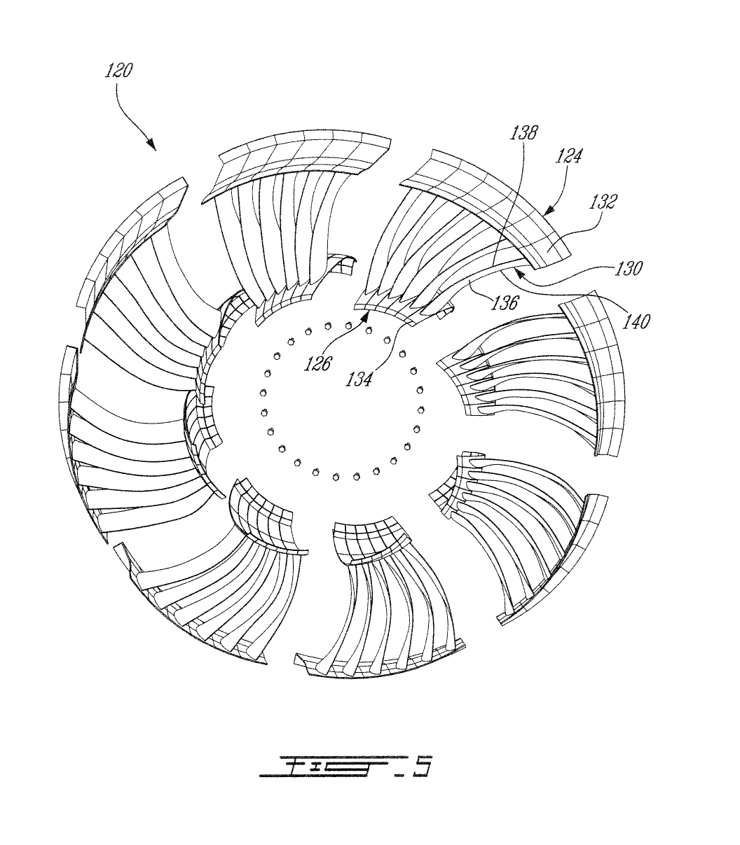

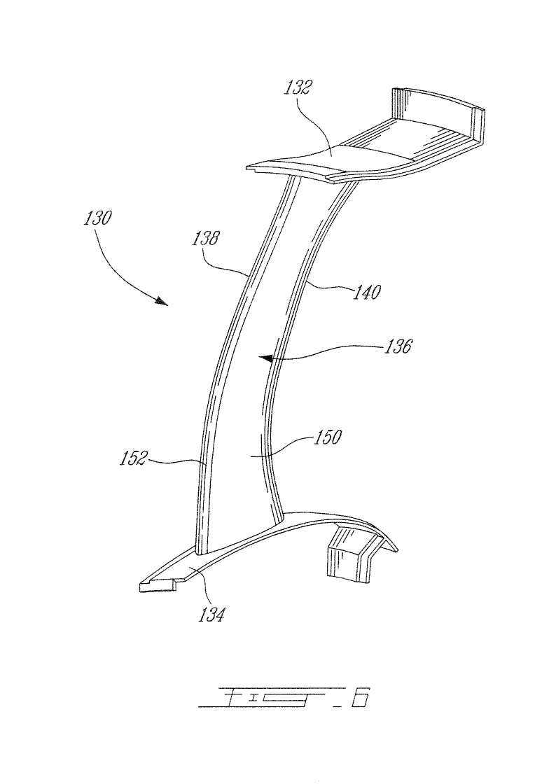

Referring to FIGS. 5-6, a stator 120 according to an alternate embodiment is shown. The stator 120 may be a core fan exit stator or a bypass fan exit stator, or alternately a stator of the compressor section 14. The stator includes a plurality of vanes 130, each having a vane root 133, a vane tip 132 and an airfoil portion 136 extending therebetween. The airfoil portion 136 defines a relatively sharp leading edge 138 and a relatively sharp trailing edge 140. In this embodiment, each vane root 134 forms a respective part of the outer shroud 124, and each vane tip 132 forms a respective part of the inner shroud 126, such that the connected vanes 130 together define the inner and outer shrouds 124, 126, i.e. each vane includes a respective portion of the inner and outer shrouds 126, 124 integral therewith. The vanes 130 can be manufactured in groups of several vanes connected to an integral shroud (not shown), or integral shroud segment as illustrated in FIG. 5, or as individual vanes as illustrated in FIG. 6.

As in the previous embodiment and as shown in FIG. 4, the vanes 130 include a core 150 made of a composite substrate covered by a single layer metal topcoat 152 of a nanocrystalline pure metal which covers at least the leading edge 138 of the airfoil of each vane 130. Similar characteristics as the previous embodiment, e.g. material, thickness, grain size, leading edge region size, method of manufacture, etc., apply and as such will not be repeated here.

The topcoat 152 applied to the stator vane 130 may be applied in any desired thickness, and as a constant thickness or with a thickness which varies as a function of position in the stator (e.g. the coating thickness may be tuned to provide structurally optimum parts, i.e thick in weak regions of the part), such as the leading edge, and thin in other regions, such as the central airfoil region.

In another aspect of this embodiment, the molecules comprising the surface of the topcoat on the stator may be manipulated on a nanoscale to affect the topography of the final surface to improve the hydrophobicity (i.e. ability of the surface to resist wetting by a water droplet) to thereby provide the stator with a superhydrophobic, self-cleaning surface which may beneficially reduce the need for anti-icing measures on the stator, and may also keep the airfoil cleaner, such that the need for a compressor wash of the airfoil is reduced.

There are three principle vane mounting configurations for which the presently described vanes can be used as fan or compressor vanes: gromments with removable vanes; potted; and integral vane and shrouds. Regardless of the mounting structure, the airfoil portions of the vanes will be as described herein.

Additionally the nanocrystalline coat may be composed of a pure Ni and is purposely not alloyed to obtain specific material properties. The manipulation of the pure Ni grain size helps produce the required mechanical properties. The topcoat 152 may be a pure nickel (Ni), cobalt (Co), or other suitable metal, such as Ag, Al, Au, Cu, Cr, Sn, Fe, Mo, Pt, Ti, W, Zn or Zr and is purposely pure not alloyed with other elements) to obtain specific material properties sought herein. In a particular embodiment, the pure metal of the nanocrystalline topcoat 152 is nickel or cobalt, such as for example Nanovate™ nickel or cobalt (trademark of Integran Technologies Inc.) respectively, although other metals can alternately be used, such as for example copper. It is to be understood that the term “pure” is intended to include a metal perhaps comprising trace elements of other components but otherwise unalloyed with another metal.

Hence, it has been found that flight worthy vanes may be provided using a bi-material vane airfoil made of a composite (ex: carbon fiber) core with a nanocrystalline metal coating, such as along the LE of the airfoil for example, may result in a significant cost advantage compared to a comparable more traditional aluminum, steel or other all-metal vane typically used in gas turbine engines. Accordingly, the present nanocrystalline metal sheath along the leading edge of the composite airfoil results in a vane that may be cheaper to produce and more lightweight than traditional solid metal vanes, while nevertheless providing comparable strength and other structural properties, and therefore comparable if not improved life-span.

The nanocrystalline topcoat applied to the vane airfoil provides improved resistance to foreign object damage (FOD) and erosion of the present composite vane in comparison with known all-metal or composite vane configurations, and therefore as a result reduced field maintenance of the gas turbine engine may be possible, as well as increased time between overhauls (TBO).

The nanocrystalline topcoat 52 has mechanical properties which are superior to those of the substrate composite material. The nanocrystalline metal LE coating 52 provides good impact resistance, which is desirable for resistance to so-called “soft” FOD caused by hail or other weather conditions, for example. Beneficially, the nanocrystalline metal topcoat may also provide erosion protection to the vane, or at a minimum provide erosion resistance comparable to conventional aluminum vanes.

The properties and configuration of the combination of the nanocrystalline metal leading edge layer 52 and the composite core substrate 50 of the presently described vane airfoils, may be selected to provide the resultant vane with a stiffness similar to a conventional aluminum vane, and which would provide the vane with dynamic frequencies and resonances comparable to a conventional aluminum vane. By providing such a composite vane having a nano-metal leading edge sheath having dynamic properties comparable to known vanes (while nevertheless having improved impact resistance and other advantages), existing data on known full-metal vanes or existing composite vanes may be more easily extrapolated to the present vane design, which may facilitate the designer in the prediction of vane performance, etc. and which may also therefore facilitate introduction of the new vane into a new production engine, or alternately as a field retrofit into an existing production engine.

In another embodiment, a standard-grain pure nickel coating (i.e. non-nanocrystalline) may be applied to the composite airfoil core, to provide a vane airfoil according to the present disclosure. The coating may be applied by an application process suitable for nanocrystalline metal materials, which may include, but is not limited to, plating, vapour deposition or any other suitable process, as described above.

A hybrid vane in accordance with the present disclosure, namely having a composite core and a nanocrystalline metal coating on at least a portion thereof, permits an overall vane that is between 10 and 40% lighter than a conventional solid aluminum vane of the same size. Further, while being more lightweight than a comparable solid aluminum vane, the present hybrid vane allows for reduced permanent deflections due to ice and similar FOD impact, by a factor of between 2 to 20 in comparison with a solid aluminum vane. Additionally, the composite core having a nanocrystalline metal coating, such as along the leading edge therefore for example, makes the composite core more resistant to FOD and erosion, and therefore it is less likely that significant degradation of the structural properties of the vane will occur. The hybrid vane construction having a composite core and a nanocrystalline metal coating may also result in a vane which is electrically conductive and thus which can be used as an engine grounding path.

The presently described hybrid vane may also be formed such that it is at least partially hollow, i.e. the composite core may comprises cavities or passages therein which are adapted to receive a hot fluid or gas flow therein which may be used for example to provide anti-icing to the external surface of the vane, and the hybrid configuration (composite core and nanocrystalline metal coating) of the present vane may accordingly enable a low-cost method of carrying a higher temperature fluid therein in comparison with solid aluminum vane airfoils.

Additionally, as noted above, the thickness of the nanocrystalline metal coating as well as the number of layers thereof, which help may help to provide the structural integrity for the hybrid vane, may be adjusted and/or varied as required on the core, for example in order to reduce stresses and stiffen the vane in order to reduce deflections in the vane and to dynamically tune the vane as required. Therefore, the ability to adjust the thickness of the structural nanocrystalline metal coating, whether by applying a single layer having increased thickness or by applying multiple layers, permits the vane or other airfoil to be stiffened as and were required in order to reduce deflections and/or dynamically tune the vane. As such, a method of adjusting the thickness of a structural nanocrystalline metal coating layer may be provided to reduce stresses, stiffen the vane in order to reduce deflections and/or to dynamically tune the vane.

Additional features and/or advantages exist with the present airfoil having the above-described nanocrystalline metal coating applied thereto. For example, this construction provides the ability to apply a nanocrystalline metal over an intricate airfoil shape, that typically cannot be achieved by existing metal application processes, in order to improve airfoil performance. The structural and/or impact strength of the present airfoils are also improved, relative to existing airfoils, by the application of the nanocrystalline metal coating on at least the LE thereof, or alternately over the entire airfoil. Given that the present airfoils comprise a non-metallic core, erosion resistance is increased, while still improving FOD resistance due to the application of the nanocrystalline metal coating on the LE of the airfoil. The present airfoils having such a non-metallic core coated with the nanocrystalline metal also enable improved corrosion resistance in comparison with existing airfoils having metallic sheaths. As noted above, the ability to achieve very small radii with the nanocrystalline metal coating at the LE of the airfoil, improved aerodynamic performance is also possible with the present airfoil construction. Further, given the ability to adjust

The above description is meant to be exemplary only, and one skilled in the art will recognize that changes may be made to the embodiments described without departing from the scope of the invention disclosed. For example, the vane may have any suitable configuration, such as individual insertable airfoils, a vane with integral inner and/or outer shrouds, a vane segment comprising a plurality of airfoils on a common inner and/or outer shroud segment, and a complete vane ring. Any suitable matrix material(s) and configurations may be used, and any suitable metal(s) may be selected for the nanocrystalline topcoat. Any suitable manner of applying the topcoat layer may be employed. Still other modifications which fall within the scope of the present invention will be apparent to those skilled in the art, in light of a review of this disclosure, and such modifications are intended to fall within the appended claims.

1. An airfoil for a gas turbine engine comprising a root, a tip, and leading and trailing edges extending between the root and the tip, the airfoil having a non-metallic core composed of a composite and a metallic coating on at least a portion of the core, the metallic coating being composed of a nanocrystalline metal forming an outer surface of said portion of the airfoil.

2. The airfoil as defined in claim 1, wherein the at least a portion of the core includes the leading edge of the airfoil.

3. The airfoil as defined in claim 2, wherein the nanocrystalline metal is confined exclusively along a leading edge region, the leading edge region covering the leading edge of the airfoil.

4. The airfoil as defined in claim 1, wherein the nanocrystalline metal is a single layer of pure metal.

5. The airfoil as defined in claim 4, wherein the pure metal is selected from the group consisting of: Ni, Co, Ag, Al, Au, Cu, Cr, Sn, Fe, Mo, Pt, Ti, W, Zn, and Zr.

6. The airfoil as defined in claim 4, wherein the nanocrystalline metal is pure nickel or cobalt.

7. The airfoil as defined in claim 1, wherein the composite substrate is a carbon-fibre composite.

8. The airfoil as defined in claim 1, wherein the metallic coating has a thickness of between 0.0005 inch and 0.125 inch.

9. The airfoil as defined in claim 8, wherein the thickness of the metallic coating is about 0.005 inch.

10. The airfoil as defined in claim 1, wherein a thickness of the metallic coating is non-constant throughout the airfoil.

11. The airfoil as defined in claim 10, wherein the thickness of the metallic coating is greatest at the leading edge of the airfoil and tapers in thickness along surfaces of the airfoil extending away from the leading edge.

12. The airfoil as defined in claim 1, wherein the nanocrystalline metal has an average grain size of between 10 nm and 500 nm.

13. The airfoil as defined in claim 12, wherein the average grain size of the nanocrystalline metal is between 10 nm and 15 nm.

14. The airfoil as defined in claim 1, wherein the metallic coating is in direct contact with the non-metallic substrate and is bonded thereto.

15. The airfoil as defined in claim 1, wherein an outer surface of the metallic coating of the nanocrystalline metal has a hydrophobic-causing topography.

16. A stator of a gas turbine engine, the stator having a plurality of vanes each having an airfoil as defined in claim 1.

17. A gas turbine engine fan including a plurality of fan blades, each of said fan blades having an airfoil as defined in claim 1.

18. A method of manufacturing an airfoil for a gas turbine engine, the method comprising the steps of:
providing a core from a composite material, the core of the airfoil defining a leading edge and a trailing edge; and
applying a nanocrystalline metal coating over at least a portion of the core.

19. The method of claim 18, wherein the step of applying includes applying a single of the nanocrystalline metal on the composite core.

20. The method of claim 19, further comprising applying a plurality of layers of the nanocrystalline metal onto the composite core.

21. The method as defined in claim 18, wherein the step of applying further comprises applying the nanocrystalline metal only over the leading edge of the airfoil.

22. The method as defined in claim 18, wherein the step of providing further comprises forming the core out of carbon fiber-reinforced composite.

23. The method as defined in claim 18, wherein the step of applying further comprises applying the nanocrystalline metal coating over the entirety of the core.
